(19) United States
(12) Patent Application Publication
(10) Pub. No.: US 2015/0285738 A1
(43) Pub. Date: Oct. 8, 2015

(54) Early warning of changes in health and robustness using narrowly forward scattered light to track ease of morphological changes of blood cells

(71) Applicants: Satish Deshpande, Guelph (CA); James Andrew Estill, Guelph (CA); Donald Franklin Moyer, Chicago, IL (US)

(72) Inventors: Satish Deshpande, Guelph (CA); James Andrew Estill, Guelph (CA); Donald Franklin Moyer, Chicago, IL (US)

(21) Appl. No.: 14/248,285

(22) Filed: Apr. 8, 2014

(51) Int. Cl. G01N 21/49

(52) U.S. Cl. CPC G01N 21/49; G01N 2201/061; G01N 2201/12; G01N 2201/022

(57) ABSTRACT

Early warning of changing health and robustness is given by tracking of ease of morphological changes in blood cells obtained by comparing intensities in a first scattered light intensity angular distribution and intensities in a second scattered light intensity angular distribution, with the light being scattered by blood cells into very narrowly forward scattered light intensity angular range.

This application claims priority of U.S. provisional patent application 61/810,253 filed 9 Apr. 2013 which is incorporated herein in full by reference.

### SUMMARY

It is a new result and unexpected discovery that early warning of changes in health and robustness can be obtained via a useful, reliable, and sensitive tracking of ease of morphological changes in blood cells using a tracking value (T) defined by a tracking equation:

T=Σ|Fᵢ−Sᵢ|,
with Fᵢ comprising first scattered light intensities in a first scattered light intensity angular distribution detected at angles i,
with Sᵢ comprising second scattered light intensities in a second scattered light angular distribution detected at angles i, and
with the summation being over angles i.

### BRIEF DESCRIPTION OF THE DRAWINGS

FIG. 1 shows scattered light intensity angular distributions:
by a first test blood sample from a first blood sample (solid curve), and
by a second test blood sample from the first blood sample (dotted curve),
with the second test blood sample being challenged for a challenge time interval by a challenge agent which can cause morphological changes in blood cells.

FIG. 2 shows scattered light intensity angular distributions:
by a first test blood sample from a second blood sample (solid curve), and
by a second test blood sample from the second blood sample (dotted curve),
with the second test blood sample being challenged for a challenge time interval by a challenge agent which can cause morphological changes in blood cells, and
with the greater change between the solid and dotted curves here being because the challenge agent could more easily cause morphological changes in the blood sample used for FIG. 2 than in the blood sample used for FIG. 1.

FIG. 3 is a compilation of measurements like those of FIG. 1 and FIG. 2 to show tracking of ease of morphological changes related to food eaten.

FIG. 4 shows scattered light intensity angular distributions:
by a first test blood sample from a first blood sample (solid curve), and
by a second test blood sample from the first blood sample (dotted curve),
with the second test blood sample being challenged for a challenge time interval by a challenge agent which can cause morphological changes in blood cells,
with the difference between the two angular distributions giving an early warning of developing pneumonia in a cow which had been constantly monitored and with no other sign of any developing problem.

FIG. 5 shows scattered light intensity angular distributions
by a first test blood sample from a blood sample (solid curve) and
by a second test blood sample from the blood sample (dotted curve) with a first antiviral added, and
by a third test blood sample (dashed curve) from the blood sample with a second antiviral added,
with the second antiviral more easily causing morphological changes.

### DETAILED DESCRIPTION

A system to track ease of morphological changes in blood cells comprises a sample container to contain blood samples having a cells per volume sample concentration.

The system also comprises an incident light source providing incident light. The incident light has an incident light central axis. The incident light central axis has a path length through blood samples in the sample container.

The system also comprises a forward scattered light angular range away from the incident light central axis.

The system also comprises a forward scattered light detector. The forward scattered light detector detects a scattered light intensity angular distribution. The scattered light intensity angular distribution comprises incident light scattered by a blood sample in the sample container into the forward scattered light angular range;

The system also comprises configuration together:
of the incident light,
of the forward scattered light detector,
of the sample concentration, and
of the incident light central axis path length through blood samples in the sample container,
so that stochastic fluctuations of orientations of electric dipole moments of blood cells in an ensemble of blood cells along the incident light central axis path length through blood samples in the sample container add incident light scattered by the ensemble into the forward scattered light angular range away from the incident light central axis;

The science of light scattering by ensembles of scatterers, which is well known to persons having ordinary skill in this art, is detailed, for example, in the book: Bruce J. Berne, Robert Pecora, Dynamic Light Scattering: With Applications to Chemistry, Biology, and Physics, Wiley, 1976 and Courier Dover Publications, 2000.

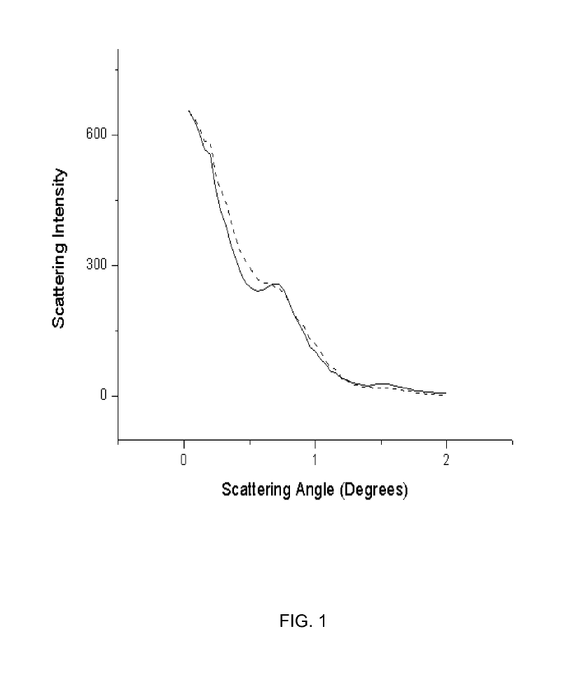

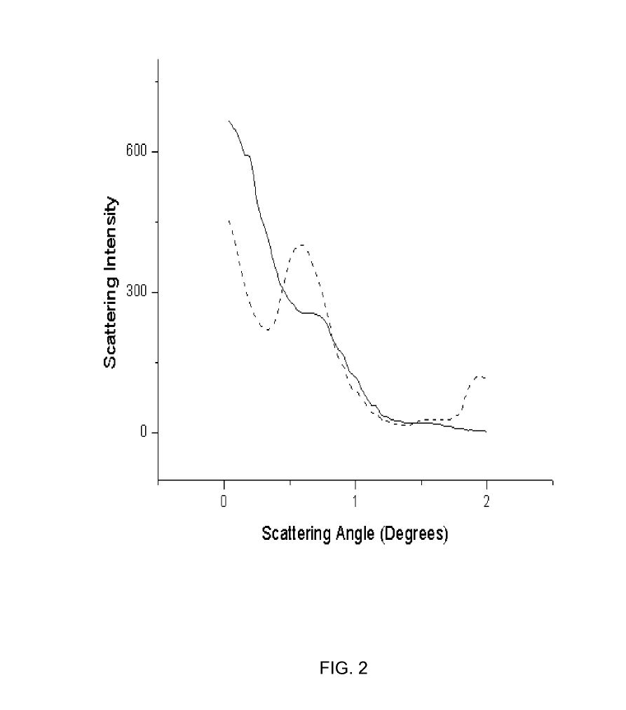

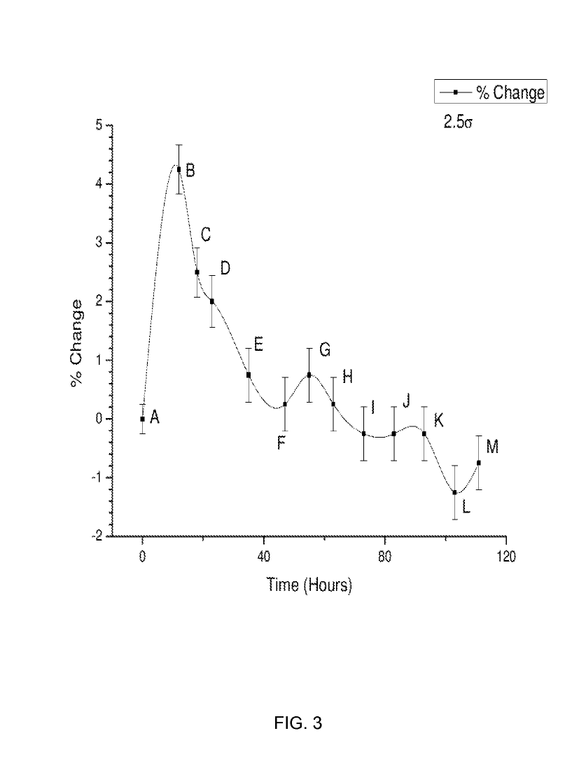

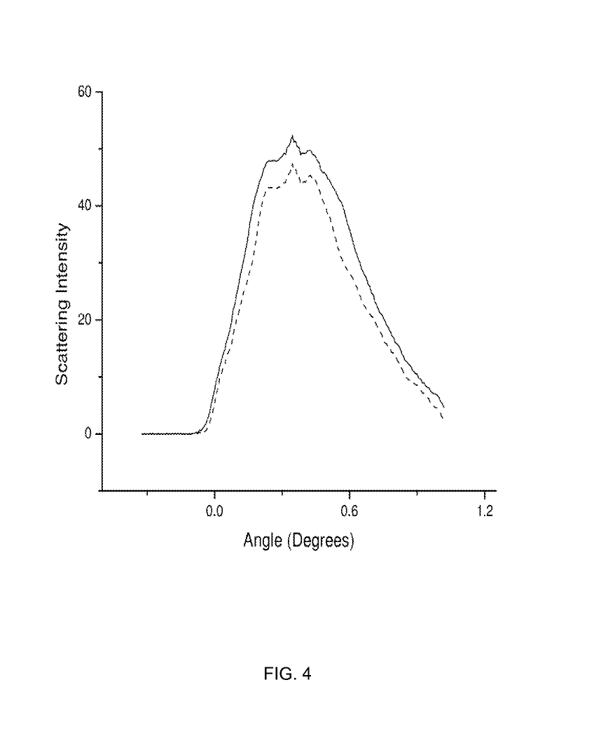

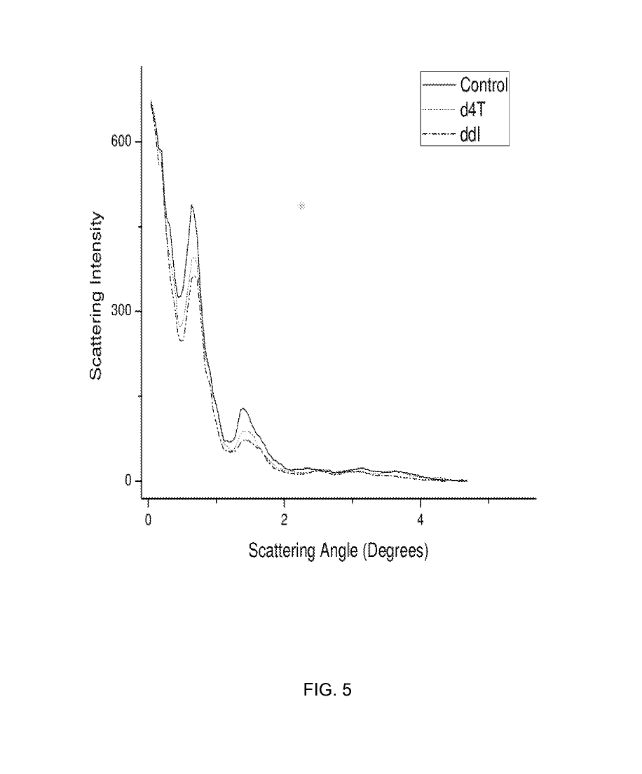

It is a new result and an unexpected discovery that the incident light, the forward scattered light detector, the sample concentration, and the path length can be configured together to track of ease of morphological changes in blood cells shown in FIG. 1, FIG. 2, FIG. 3, FIG. 4, and FIG. 5.

It is a new result and an unexpected discovery that useful, reliable, and sensitive tracking of ease of morphological change in blood cells can be obtained from light scattered by the blood cells into a narrow forward angular range which includes at least a first blood cell scattering peak and a second blood cell scattering peak which can be seen below one degree in FIG. 1 and FIG. 2.

The location of these two scattering peaks depends on the wavelength of incident light.

Sensitive and reliable results are obtained using a 780 nm wavelength laser, path lengths of 2 mm and 10 mm in samples diluted to 5% blood and 95% physiological phosphate buffered saline (buffer), with longer path lengths requiring a greater amount of buffer. Other wavelengths, path lengths, and buffers can also provide sensitive and reliable results.

The system also comprises a first test blood sample obtained from the blood sample and a second test blood sample obtained from the blood sample. Subsequent test blood samples can also be obtained from the blood sample.

The system also comprises a first scattered light intensity angular distribution detected by the forward scattered light detector. The first scattered light intensity angular distribution comprises incident light scattered by the first test blood sample in the sample container into the forward scattered light angular range.

For the detecting, accumulation of 100 to 500 exposures by a CMOS CCD sensor with 640×480 pixels per inch at a speed of 50 millisecond/exposure provides sensitive and reliable results. Other detectors and exposure accumulations can also give sensitive and reliable results.

The system also comprises a second scattered light intensity angular distribution detected by the forward scattered light detector. The second scattered light intensity angular distribution comprises incident light scattered by the second test blood sample in the sample container into the forward scattered light angular range. There is a challenge time interval before obtaining the second scattered light intensity angular distribution.

A challenge agent which can cause morphological change to blood cells can challenge the second test blood sample for the challenge time interval.

There are many ways the first test blood sample and the second test blood sample might be obtained. For example, the first test blood sample and the second test blood sample can be obtained from the same blood sample and the challenge agent added to the second test blood sample. Then the first scattered light intensity angular distribution obtained from the first test blood sample. After the challenge time interval the second scattered light intensity angular distribution can be obtained from the second test blood sample to which the challenge agent was added.

For example, the first test blood sample can be obtained from the blood sample and the first scattered light intensity angular distribution obtained. Then, the challenge agent added to the first test blood sample to make it the second test blood sample, and then after the challenge time interval, the second scattered light intensity angular distribution can be obtained. This example assumes that there is no important change in the first test blood sample before the challenge agent is added.

For example, the first test blood sample can be obtained from the blood sample and the first scattered light intensity angular distribution obtained. Later the second test blood sample can be obtained from the blood sample and the challenge agent added to the second test blood sample. After the challenge time interval the second scattered light intensity angular distribution can be obtained. This example assumes that there is no important change to the blood sample between obtaining the first test blood sample and the second test blood sample.

For example, the challenge agent can be added to at least part of the blood sample and the first test blood sample obtained from the blood sample and the first scattered light intensity angular distribution obtained. Then after the challenge time interval the second test blood sample can be obtained from the part of the blood sample with the challenge agent and the second scattered light intensity angular distribution obtained.

For example, the second test blood sample can be obtained from an organism after the organism had a treatment. In this example, the treatment is the challenge agent.

FIG. 1 and FIG. 2 show first scattered light intensity angular distribution and a second scattered light intensity angular distribution. A challenge agent which can cause morphological change to blood cells challenged the second test blood samples before obtaining the second scattered light intensity angular distributions.

The difference occurs because the cells are morphologically changed by the challenge agent. Large scatterers, such as cells and cell nuclei for example, scatter into the narrowly forward angular range. Smaller scatterers such as other cell parts for example, scatter to larger forward angular range. Challenge agents can be selected to affect various cell parts. Conversely, it can be determined what parts of cells are being affected by challenge agents by changes in the angular range.

FIG. 1 is for “good nutritional status” because that is the self-report by the person providing this blood sample. FIG. 2 is for “poor nutritional status” because that is the self-report by the person providing this blood sample.

The difference between FIG. 1 and FIG. 2 shows that “poor nutritional status” makes it easier for a challenge agent to cause morphological change.

In FIG. 1, FIG. 2, FIG. 4, and FIG. 5 the numbers along the vertical axes are scattering intensities in arbitrary units. The numbers along the horizontal axes are angles away from the incident light central axis. Light very close to zero degrees is blocked to prevent the saturation of the detector by the laser.

The system also comprises a tracking value which tracks change between the first scattered light intensity angular distribution and the second scattered light intensity angular distribution.

A tracking value (T) can be obtained using a tracking equation:

T=Σ|Fᵢ−Sᵢ|,
with Fᵢ comprising first scattered light intensities in the first scattered light intensity angular distribution detected at angles i,
with Sᵢ comprising second scattered light intensities in the second scattered light angular distribution detected at angles i, and
with the summation being over angles i.

There are many ways, including just visual inspection, that change between a first scattered light intensity angular distribution and a second scattered light intensity angular distribution might be tracked. It is a new result and unexpected discovery that the tracking equation above provides sensitive, reliable, and useful results.

Challenge agents are any agents which can cause morphological change to blood cells like that shown in FIG. 1 and FIG. 2. Challenge agents can be reactive oxygen species such as hydrogen peroxide. Challenge agents can be treatments such as the antivirals of FIG. 5. Challenge agents can be pathogens. Challenge agents can be chemicals such as antibiotics. Challenge agents can be electromagnetic radiation.

In FIG. 1, FIG. 2, FIG. 3, and FIG. 4 the challenge agent was hydrogen peroxide with a fifteen second challenge time interval.

Results equivalent to results seen in FIG. 1, FIG. 2, FIG. 3, and FIG. 4 can be obtained using ultraviolet light as the challenge agent. Using ultraviolet light has the advantage of being more easily standardized and does not involve a mechanical step of adding a challenge agent to a sample.

More than one means to challenge a sample can be used singly and alternatively together and alternatively serially. When no challenge agent is added and there is a challenge time interval between a first scattered light intensity angular distribution and a second scattered light intensity angular distribution, the tracking value will show change over time due to intrinsic challenge.

Tracking over time of the ease of morphological change to blood cells in relation to food eaten is shown in FIG. 3. The vertical axis is percent change of the tracking value, all percent changes reckoned from the tracking value (T) at zero point—data point A—at zero hours. The horizontal axis is elapsed hours.

An increase occurs when the challenge agent more quickly causes morphological change to blood cells that result in an increase in the tracking value. A decrease occurs when the challenge agent less quickly causes morphological change to blood cells that result in a decrease in the tracking value.

Data points labeled A, B, C, D, E, F, G, H, I, J, K, L, and M correspond to tracking values obtained using the equation for tracking value from measurements like those shown in FIG. 1 and FIG. 2 made at each of the labeled data points.

This tracking example is related to changes in the tracking value resulting from the food eaten: About forty five minutes after data point A the person ate an 8 oz steak, fries, carrots, cheesecake, and wine. Just after data point B the person ate spinach salad with cheese vinegar/olive oil dressing and four oz. chicken. Shortly before data point D the person ate tomato soup, grilled salmon, spinach salad with vinegar/olive oil dressing, and almonds. Shortly before data point F the person ate oatmeal. Mid-way between data points H and I the person ate fish and vegetables. Shortly after data point J the person ate fish and vegetables.

FIG. 4 shows early warning of developing pneumonia in a cow. This cow had been constantly monitored by a thermometer in the fore-stomach. The thermometric tracking showed no sign of a developing problem. The system described and claimed here gave an early warning leading to early treatment so that full pneumonia did not develop and the cow recovered quickly.

Another cow was not expected to recover from E. coli. The system described and claimed here showed that the cow was getting close to normal after antibiotic treatment which turned out the case.

Early work with race horses indicates that increasing ease of morphological change of blood cells shown by the tracking value (T) gives early warning of decrease of robustness shown by decrease of performance in speed and endurance.

In an option, the system can also comprise a third test blood sample obtained from the blood sample and a third scattered light intensity angular distribution detected by the forward scattered light detector obtained after the challenge time interval between the first scattered light intensity angular distribution and third scattered light intensity angular distribution. The third scattered light intensity comprising incident light scattered by the third test blood sample in the sample container into the forward scattered light angular range.

In this option a second challenge agent which can cause morphological change to blood cells can challenge the third test blood sample for the challenge time interval.

In this option a second tracking value between the first scattered light intensity angular distribution and the third scattered light intensity angular distribution can be determined.

FIG. 5 shows:
a first scattered light intensity angular distribution (solid curve) scattered by a first test blood sample obtained from a blood cells sample from a person infected with HIV/AIDS,
a second scattered light intensity angular distribution (dotted curve) scattered by a second test blood sample obtained from the blood cells sample with a first antiviral efficacious for the HIV/AIDS infection of the person challenging the second test blood sample for the challenge time interval, and
a third scattered light intensity angular distribution (dashed curve) scattered by a third test blood sample obtained from the blood cells sample with a second antiviral equally efficacious for the HIV/AIDS infection of the person challenging the third test blood sample for the challenge time interval.

Visual inspection of these three distributions shows that the second antiviral more easily causes morphological change to the person's blood, which is useful clinical information.

The new and unexpected result shown in FIG. 5 can also be obtained in comparison of treatments for various conditions.

FIG. 1, FIG. 2, FIG. 3, FIG. 4, and FIG. 5 show that the unexpected discoveries here provide new, reliable, sensitive, and useful tracking of ease of morphological changes in blood cells.

“Reliable” here means that the changes between first and second scattered light intensity angular distributions, depicted in FIG. 1 for example, are greater than random changes so that if the measurements, of FIG.1 and FIG. 2 for example, were repeated many times, then the results would fall in a narrow confidence interval with high probability. For example, 99.4% of measurement repetitions for each of the measurements in FIG. 3 would fall within the error bars shown for each data point.

“Sensitive” here means that changes depicted in FIG. 1 and in FIG. 2, for example, track small percent changes as depicted in FIG. 3.

“Useful” here means that changes depicted in FIG. 1, FIG. 2, FIG. 3, FIG. 4, and FIG. 5 can be related to health and robustness. Greater ease of morphological change of blood cells by challenge agents can occur because of an otherwise pre-symptomatic infection, because of poor diet, because of effects of treatments, or because of various factors which make it easier for challenge agents to cause morphological changes in blood cells.

Blood samples can be whole blood and can be less than all the constituents of whole blood. For example, the blood cells used in the measurements shown in FIG. 5 had a portion of white blood cells removed.

Claimed is:

1. A system to track morphological changes in blood cells, the system comprising:
1.1. a sample container to contain blood samples having a cells per volume sample concentration;
1.2. an incident light source providing incident light,
1.2.1. the incident light having an incident light central axis,
1.2.2. the incident light central axis having a path length through blood samples in the sample container;
1.3. a forward scattered light detector;
1.3.1. the forward scattered light detector detecting a scattered light intensity angular distribution,
1.3.2. the scattered light intensity angular distribution comprising incident light scattered by a test blood sample in the sample container into a forward scattered light angular range;
1.4. configuration together:
1.4.1. of the incident light,
1.4.2. of the forward scattered light detector,
1.4.3. of the sample concentration, and
1.4.4. of the incident light central axis path length through blood samples in the sample container,
so that stochastic fluctuations of orientations of electric dipole moments of blood cells in an ensemble of blood cells along the incident light central axis path length through blood samples in the sample container add incident light scattered by the ensemble into the forward scattered light angular range away from the incident light central axis;
1.5. a first test blood sample obtained from a blood sample and a second test blood sample obtained from the blood sample;
1.6. a first scattered light intensity angular distribution detected by the forward scattered light detector,
1.6.1. the first scattered light intensity comprising incident light scattered by the first test blood sample in the sample container into the forward scattered light angular range,
1.7. a second scattered light intensity angular distribution detected by the forward scattered light detector,
1.7.1. the second scattered light intensity comprising incident light scattered by the second test blood sample in the sample container into the forward scattered light angular range,
1.7.2. with a challenge time interval before obtaining the second scattered light intensity angular distribution; and
1.8. a tracking value tracking change between the first scattered light intensity angular distribution and the second scattered light intensity angular distribution.

2. The system of claim 1 with added limitations that the tracking value (T) is obtained using a tracking equation:
T=Σ|Fᵢ−Sᵢ|,
2.1. with Fᵢ comprising first scattered light intensities in the first scattered light intensity angular distribution detected at angles i,
2.2. with Sᵢ comprising second scattered light intensities in the second scattered light angular distribution detected at angles i, and
2.3. with the summation being over angles i.

3. The system of claim 1 with added limitations that a challenge agent which can cause morphological change to blood cells challenges the second test blood sample for the challenge time interval.

4. The system of claim 3 with added limitations comprising:
4.1. a third test blood sample obtained from the blood sample;
4.2. a third scattered light intensity angular distribution detected by the forward scattered light detector;
4.2.1. the third scattered light intensity comprising incident light scattered by the third test blood sample in the sample container into the forward scattered light angular range;
4.3. a second challenge agent which can cause morphological change to blood cells having challenged the third test blood sample for a second challenge time interval before obtaining the third scattered light intensity angular distribution; and
4.4. determination of a second tracking value between the first scattered light intensity angular distribution and the third scattered light intensity angular distribution.

5. A system to track morphological changes in blood cells, the system comprising:
5.1. a sample container to contain blood samples having a cells per volume sample concentration;
5.2. an incident light source providing incident light,
5.2.1. the incident light having an incident light central axis,
5.2.2. the incident light central axis having a path length through blood samples in the sample container;
5.3. a forward scattered light detector;
5.3.1. the forward scattered light detector detecting a scattered light intensity angular distribution,
5.3.2. the scattered light intensity angular distribution comprising incident light scattered by a test blood sample in the sample container into a forward scattered light angular range;
5.4. configuration together:
5.4.1. of the incident light,
5.4.2. of the forward scattered light detector,
5.4.3. of the sample concentration, and
5.4.4. of the incident light central axis path length through blood samples in the sample container,
so that stochastic fluctuations of orientations of electric dipole moments of blood cells in an ensemble of blood cells along the incident light central axis path length through blood samples in the sample container add incident light scattered by the ensemble into the forward scattered light angular range away from the incident light central axis;
5.5. a first test blood sample obtained from a blood sample and a second test blood sample obtained from the blood sample;
5.6. a first scattered light intensity angular distribution detected by the forward scattered light detector,
5.6.1. the first scattered light intensity comprising incident light scattered by the first test blood sample in the sample container into the forward scattered light angular range,
5.7. a second scattered light intensity angular distribution detected by the forward scattered light detector,
5.7.1. the second scattered light intensity comprising incident light scattered by the second test blood sample in the sample container into the forward scattered light angular range,
5.7.2. with a challenge agent challenging the second test blood sample for a challenge time interval before obtaining the second scattered light intensity angular distribution; and
5.8. a tracking value (T) being obtained using a tracking equation:
T=Σ|Fᵢ−Sᵢ|,
5.8.1. with Fᵢ comprising first scattered light intensities in the first scattered light intensity angular distribution detected at angles i,
5.8.2. with Sᵢ comprising second scattered light intensities in the second scattered light angular distribution detected at angles i, and
5.8.3. with the summation being over angles i.

6. The system of claim 5 with added limitations comprising:
6.1. a third test blood sample obtained from the blood sample;
6.2. a third scattered light intensity angular distribution detected by the forward scattered light detector;
6.3. the third scattered light intensity comprising incident light scattered by the third test blood sample in the sample container into the forward scattered light angular range;
6.4. a second challenge agent which can cause morphological change to blood cells challenging the third test blood sample for a second challenge time interval before obtaining the third scattered light intensity angular distribution; and
6.5. determination of a second tracking value between the first scattered light intensity angular distribution and the third scattered light intensity angular distribution.
